(19) United States
(12) Patent Application Publication
(10) Pub. No.: US 2016/0372005 A1
(43) Pub. Date: Dec. 22, 2016

(54) SYSTEM AND METHOD FOR PROVIDING ASSISTANCE FOR COOKING FOOD ITEMS IN REAL-TIME

(71) Applicant: Wipro Limited, Bangalore (IN)

(72) Inventors: Anvita BAJPAI, Bangalore (IN); Vinod PATHANGAY, Bangalore (IN)

(73) Assignee: Wipro Limited

(21) Appl. No.: 14/819,543

(22) Filed: Aug. 6, 2015

(30) Foreign Application Priority Data
Jun. 22, 2015 (IN) 3126/CHE/2015

(51) Int. Cl. G09B 19/00; A47J 36/00; G09B 5/06

(52) U.S. Cl. CPC G09B 19/0092; G09B 5/065; A47J 36/00

(57) ABSTRACT

Embodiments of present disclosure disclose a method for providing assistance for cooking food items in real-time. The method comprises extracting instruction steps corresponding to food recipe from sources. The method comprises receiving sensor inputs from sensors indicating execution of each of the instruction steps. The sensor inputs comprises user actions for performing each of corresponding instruction steps, one or more cooking parameters of each of the corresponding instruction steps, and utilization of cooking articles during each of the corresponding instruction steps. The method comprises comparing the sensor inputs indicating the execution of each of the instruction steps with predefined cooking data of corresponding instruction steps. The method comprises providing recommendation associated with the execution of each of the instruction steps in real-time based on the comparison for providing assistance for cooking in real-time. Embodiments generate instruction steps of cooking in real-time.

### PRIORITY CLAIM

This U.S. patent application claims priority under 35 U.S.C. §119 to India Application No. 3126/CHE/2015, filed Jun. 22, 2015. The entire contents of the aforementioned application are incorporated herein by reference.

### TECHNICAL FIELD

The present subject matter is related, in general to cooking aid and more particularly, but not exclusively to an assistance system for providing assistance for cooking food items in real-time and a recipe generating system for generating instruction steps of a food recipe in real-time for cooking food items and methods thereof.

### BACKGROUND

Cooking is an art of preparing a dish or a food item. Cooking involves numerous techniques to prepare the dish or the food item with a specific taste, aroma and color. For preparing the food item or the dish, there may be numerous cooking techniques.

Presently, a person wishing to prepare the food item or the dish makes use of a recipe book, videos, websites, applications etc. The person follows one or more cooking instructions one by one as provided in the recipe book, the videos, the websites, the applications etc. However, such a way of following the one or more cooking instructions by the person is time consuming. Particularly, the person first reads through the recipe book, collects all the ingredients and the cooking articles required and then starts following the one or more cooking instructions one by one. Alternatively, the person first watches the videos, and notes down timing of following the one or more cooking instructions and quantity of ingredients to be used. Then, the person starts preparing the food item as per the sequence of instructions in the videos.

Presently, the person is never intimated if any mistake is made while preparing or cooking the food item. For example, the person is never alerted if the person has used a wrong ingredient, has used the ingredient in excess quantity or has set the flame level wrongly. Presently, the person has to verify the one or more cooking parameters manually i.e. there is no automatic and dynamic way of verification of the one or more cooking instructions performed by the person.

Further, there may be a scenario where the person is not present in the cooking area while cooking. For example, the person may be in other area of house away from kitchen for some time period. In such a case, the food item may get burnt or the taste of the food item changes due to variation in following the one or more cooking instructions. Conventionally, there is no automatic and dynamic way of controlling the cooking of the food item. Therefore, existing assistance methods such as referring to recipe books, videos or the applications for assisting the person/is time consuming and not interactive. Also, the existing methods do not provide alert and/or recommendation in real-time upon verifying the one or more cooking instructions being performed by the person.

Furthermore, conventionally, there is no mechanism to generate the one or more cooking instructions dynamically and in real-time. The one or more cooking instructions of the food item is pre-generated i.e. the one or more cooking instructions are not created in real-time and dynamically. For example, video is uploaded in the website, the recipe is uploaded which is pre-generated. Conventionally, there is no mechanism to observe user actions while cooking, detect the ingredients and the articles used by the person while cooking, detect the color and aroma of the food item being cooked at specific time intervals and as per ingredients along with cooking stages and quantity of ingredients used while cooking at each cooking stage. There is no mechanism to generate the cooking instructions dynamically and in real-time from the user actions along with information of ingredients, the cooking articles, timings and quantity of usage of the ingredients and the cooking articles while cooking.

### SUMMARY

Disclosed herein is a method for providing assistance for cooking food items in real-time. The method comprises extracting one or more instruction steps corresponding to at least one food recipe of at least one food item from one or more sources. The method comprises receiving sensor inputs from one or more sensors indicating execution of each of the one or more instruction steps. The sensor inputs comprises user actions for performing each of corresponding one or more instruction steps, one or more cooking parameters of each of the corresponding one or more instruction steps, and utilization of one or more cooking articles during each of the corresponding one or more instruction steps. The method comprises comparing the sensor inputs indicating the execution of each of the one or more instruction steps with predefined cooking data of corresponding one or more instruction steps. The method comprises providing recommendation associated with the execution of each of the one or more instruction steps in real-time based on the comparison for providing assistance for cooking the at least one food item in real-time.

In an aspect of the present disclosure, an assistance system for providing assistance for cooking food items in real-time is disclosed. The assistance system comprises a processor and a memory communicatively coupled to the processor. The memory stores processor-executable instructions, which, on execution, cause the processor to extract one or more instruction steps corresponding to at least one food recipe of at least one food item from one or more sources. The processor then receives sensor inputs from one or more sensors indicating execution of each of the one or more instruction steps. The sensor inputs comprises user actions for performing each of corresponding one or more instruction steps, one or more cooking parameters of each of the corresponding one or more instruction steps, and utilization of one or more cooking articles during each of the corresponding one or more instruction steps. The processor compares the sensor inputs indicating the execution of each of the one or more instruction steps with predefined cooking data of corresponding one or more instruction steps. Then, the processor provides recommendation associated with the execution of each of the one or more instruction steps in real-time based on the comparison for providing assistance for cooking the at least one food item in real-time.

Disclosed herein is a method for generating instruction steps of a food recipe in real-time for cooking food items. The method comprises receiving sensor inputs from one or more sensors corresponding to cooking of the food item. The method comprises generating one or more cooking steps based on the sensor inputs. The method comprises identifying user actions performed for the cooking, one or more cooking parameters associated the cooking, utilization of one or more cooking articles associated with the cooking, and time duration of utilizing the one or more cooking articles, for each of the one or more cooking steps. The method comprises correlating the user actions, the one or more cooking parameters, the one or more cooking articles, and the time duration of each of the corresponding one or more cooking steps. The method comprises generating one or more instruction steps of the food recipe in real-time using the correlation from each of the corresponding one or more cooking steps for cooking the food item.

In an aspect of the present disclosure, a recipe generating system for generating instruction steps of a food recipe in real-time for cooking food items is disclosed. The recipe generating system comprises a processor and a memory communicatively coupled to the processor. The memory stores processor-executable instructions, which, on execution, cause the processor to receive sensor inputs from one or more sensors corresponding to cooking of the food item. The processor generates one or more cooking steps based on the sensor inputs. Then, the processor identifies user actions performed for the cooking, one or more cooking parameters associated the cooking, utilization of one or more cooking articles associated with the cooking, and time duration of utilizing the one or more cooking articles, for each of the one or more cooking steps. The processor correlates the user actions, the one or more cooking parameters, the one or more cooking articles, and the time duration of each of the corresponding one or more cooking steps. The processor generates one or more instruction steps of the food recipe in real-time using the correlation from each of the corresponding one or more cooking steps for cooking the food item.

In another aspect of the present disclosure, a non-transitory computer readable medium for providing assistance for cooking food items in real-time is disclosed. The non-transitory computer readable medium includes instructions stored thereon that when processed by a processor causes extracting one or more instruction steps corresponding to at least one food recipe of at least one food item from one or more sources. Then, sensor inputs are received from one or more sensors indicating execution of each of the one or more instruction steps. The sensor inputs comprises user actions for performing each of corresponding one or more instruction steps, one or more cooking parameters of each of the corresponding one or more instruction steps, and utilization of one or more cooking articles during each of the corresponding one or more instruction steps. The sensor inputs indicating the execution of each of the one or more instruction steps are compared with predefined cooking data of corresponding one or more instruction steps. Then, recommendation associated with the execution of each of the one or more instruction steps is provided in real-time based on the comparison for providing assistance for cooking the at least one food item in real-time.

In another aspect of the present disclosure, a non-transitory computer readable medium for generating instruction steps of a food recipe in real-time for cooking food items is disclosed. The non-transitory computer readable medium includes instructions stored thereon that when processed by a processor causes receiving sensor inputs from one or more sensors corresponding to cooking of the food item. Then, one or more cooking steps are generated based on the sensor inputs. User actions performed for the cooking, one or more cooking parameters associated the cooking, utilization of one or more cooking articles associated with the cooking, and time duration of utilizing the one or more cooking articles, for each of the one or more cooking steps are identified. The user actions, the one or more cooking parameters, the one or more cooking articles, and the time duration of each of the corresponding one or more cooking steps are correlated. Then, one or more instruction steps of the food recipe are generated in real-time using the correlation from each of the corresponding one or more cooking steps for cooking the food item.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an environment for providing assistance in real-time for cooking food items in accordance with some embodiments of the present disclosure;

FIG. 2 illustrates an environment for generating instruction steps of a food recipe of a food item in real-time in accordance with some embodiments of the present disclosure;

FIG. 3 illustrates an exemplary embodiment of environment for providing assistance in real-time for cooking food items in accordance with some embodiments of the present disclosure;

FIG. 4 illustrates a block diagram of an exemplary assistance system with various data and modules for providing assistance in real-time for cooking food items in accordance with some embodiments of the present disclosure;

FIG. 5 illustrates an exemplary embodiment of environment for generating instruction steps of a food recipe of a food item in real-time in accordance with some embodiments of the present disclosure;

FIG. 6 illustrates a block diagram of an exemplary recipe generating system with various data and modules for generating instruction steps of food recipe for cooking food item in accordance with some embodiments of the present disclosure;

FIG. 7a shows different cooking stages for generating instruction steps for each cooking stage in accordance with some embodiments of the present disclosure;

FIG. 7b shows an exemplary diagram illustrating instruction steps generated for each cooking step in accordance with some embodiments of the present disclosure;

FIG. 8 shows a flowchart illustrating a method for providing assistance in real-time for cooking food items in accordance with some embodiments of the present disclosure;

FIG. 9 shows a flowchart illustrating a method for generating instruction steps of a food recipe in real-time for cooking food items in accordance with some embodiments of the present disclosure; and

FIG. 10 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

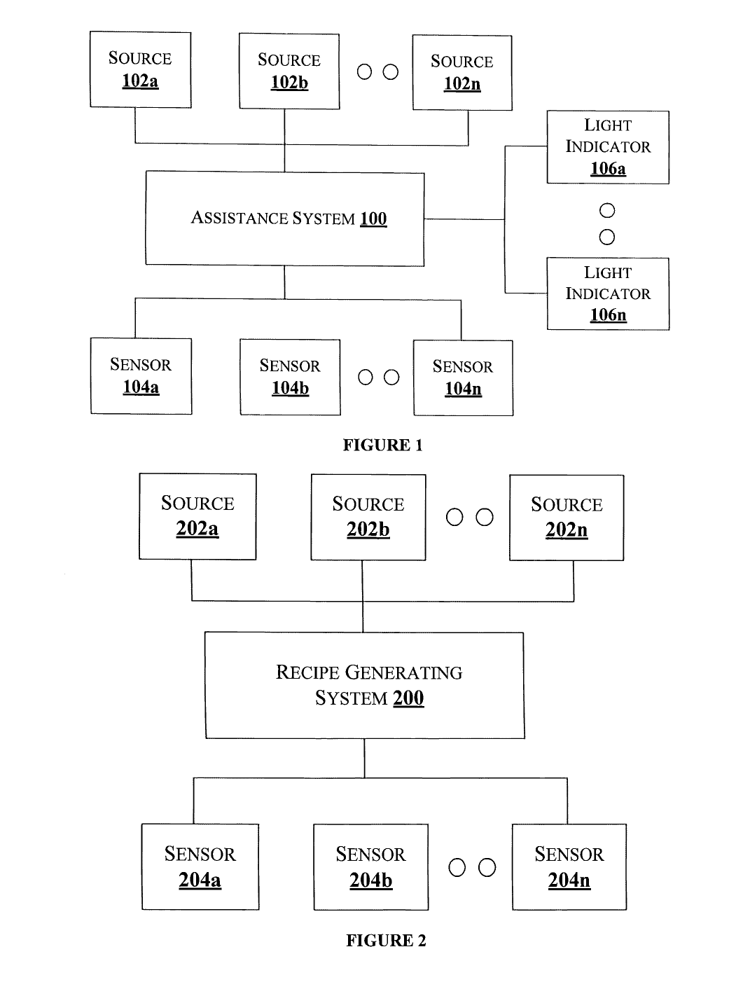

Embodiments of the present disclosure are related to a method for providing assistance in real-time for cooking food items. Particularly, the assistance for cooking is provided in real-time and dynamically by using an assistance system. In such a way, a user who can be cook, any other person cooking the food item, is intimated with alerts if any mistake is made while cooking. Also, the user is provided with recommendations as to kind of ingredients to be used or the flame level to be maintained, quantity of ingredients to be used, or corrective measures to correct cooking techniques while cooking the food items and other related cooking measures. FIG. 1 shows an assistance system 100 for providing assistance in real-time and dynamically for cooking food items. The assistance system 100 is communicatively connected to one or more sources 102a, 102b, . . . , 102n (collectively referred to 102), one or more sensors 104a, 104b, . . . , 104n (collectively referred to 104) and one or more light indicators 106a, 106b, . . . , 106n (collectively referred to 106). The one or more sources 102 include, without limitations, servers associated to the assistance system 100, third party servers and storage of the assistance system 100. The one or more sources 102 contain one or more instruction steps which are cooking steps of at least one food recipe of at least one food item. The one or more sensors 104 are configured in one or more cooking articles (not shown in FIG. 1) which include, without limitations, vessels, utensils, ingredient containers, spatulas, spoons, gas stove, electric stove, etc. The one or more sensors 104 can be also placed in areas where cooking is carried out in order to detect cooking parameters such as aroma/smell of the food item, moisture of the food item, color of the food item in each cooking stage while cooking, flame level of the gas stove or temperature of electric stove etc. The one or more light indicators 106 are configured in the one or more cooking articles in order to indicate recommendations and/or the alerts. The method for providing assistance comprises extracting the one or more instruction steps corresponding to the at least one food recipe of the at least one food item from the one or more sources 102. The one or more instruction steps are extracted when user selection of the at least one food item among a plurality of food items is received from the user. The extracted one or more instruction steps is provided to audio-visual unit associated with the assistance system 100. The user performs the one or more instruction steps. For example, the user uses particular ingredients at a time specified in the one or more instruction steps, the user uses a specific quantity of ingredients, the user uses the one or more cooking articles as specified in the one or more instruction steps, the user performs one or more actions etc. From the one or more sensors 104 sensors inputs indicating execution of each of the one or more instruction steps are received. The sensor inputs comprise user actions performing each of corresponding one or more instruction steps, one or more cooking parameters of each of the corresponding one or more instruction steps, and utilization of the one or more cooking articles during each of the corresponding one or more instruction steps. For example, consider five instruction steps to be performed for cooking the food item. The assistance system 100 receives sensors inputs comprising the user actions through camera as one of the one or more sensors 104. Particularly, through camera the user actions are observed in live to verify whether the user is performing each instruction steps during corresponding instruction steps. In an embodiment, the user actions may refer to multiple users or cooks performing the one or more instruction steps, and not restricting to single user. At each instruction step, the one or more cooking parameters include, without limitations, aroma and/or smell resulted during each instruction step of cooking, flame level of gas stove or temperature of the electric stove, color of the food item resulted while cooking, moisture of the food item, steaming level while cooking etc. The utilization of the one or more cooking articles refers the quantity of ingredients used as per each instruction step along with time of using the ingredients, the kind of ingredients and vessels, stoves used while cooking etc. The sensor inputs indicating the execution of each of the one or more instruction steps are compared with predefined cooking data of corresponding one or more instruction steps. Based on the comparison, recommendation is provided in real-time and dynamically for providing assistance in real-time. The recommendation includes, without limitations, providing alerts based on at least one of identifying a change in the user actions in performing the corresponding one or more instruction steps, identifying a delay of the user actions in performing the corresponding one or more instruction steps, absence of a user while cooking, identifying a variation in the one or more cooking parameters during the corresponding one or more instruction steps and incorrect utilization of the one or more cooking articles for the corresponding one or more instruction steps. The one or more light indicators 106 are used to intimate the user the one or more cooking articles to be used as per the one or more instruction steps. The one or more cooking articles are controlled based on the absence of the user while cooking and/or the identification of delay of user actions in performing the corresponding one or more instruction steps. The one or more cooking articles are controlled by transmitting signals to the one or more cooking articles, where both the assistance system 100 and the one or more cooking articles may comprise transceiver (not shown) respectively. In an embodiment, the recommendation and the alerts can be provided to one or more user devices (not shown) which is used by the user.

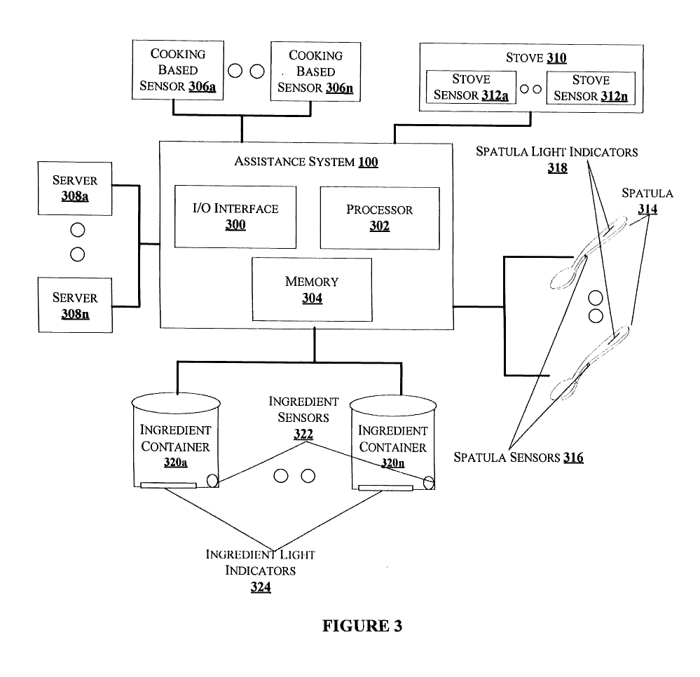

Embodiments of the present disclosure are related to a method for generating instruction steps of a food recipe in real-time for cooking food items. Particularly, the generation of the instruction steps is performed in real-time by a recipe generating system. FIG. 2 shows the recipe generating system 200 for generating the instruction steps in real-time. The recipe generating system 200 is communicatively connected to one or more sources 202a, 202b, . . . , 202n (collectively referred to 202) and one or more sensors 204a, 204b, . . . , 204n (collectively referred to 204). The one or more sources 202 and the one or more sensors 204 refer to such sources and sensors as mentioned in above description of the assistance system 100. The method comprises receiving sensor inputs comprising user actions, one or more cooking articles used and one or more cooking parameters of each preparation step from one or more sensors corresponding to cooking of the food item. Then, the method comprises generating one or more cooking steps based on the sensor inputs. The user actions performed for the cooking, the one or more cooking parameters associated the cooking, utilization of the one or more cooking articles associated with the cooking, and time duration of utilizing the one or more cooking articles, are identified for each of the one or more cooking steps. Then, for each of the corresponding cooking step, the user actions, the one or more cooking parameters, the one or more cooking articles, and the time duration are correlated to one another. Then, one or more instruction steps of the food recipe are generated in real-time using the correlation of each of the corresponding one or more cooking steps for cooking the food item.

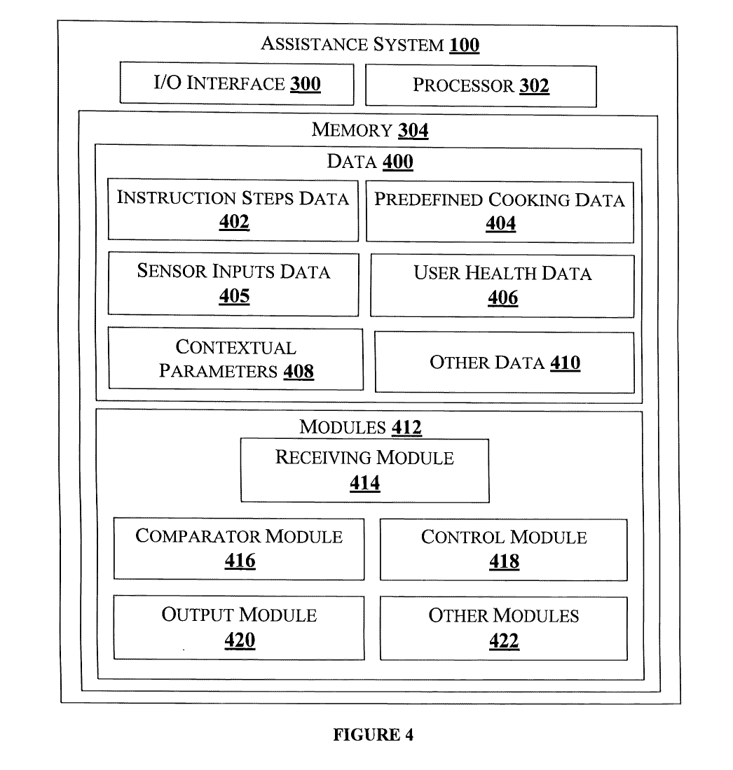

FIG. 3 illustrates a block diagram of an assistance system 100 comprising an I/O interface 300, a processor 302 and a memory 304 in accordance with some embodiments of the present disclosure.

Examples of the assistance system 100 includes, but is not limited to, mobile phone, television, digital television, laptop, tablet, desktop computer, Personal Computer (PC), contactless device, smartwatch, notebook, audio- and video-file players (e.g., MP3 players and iPODs), and e-book readers (e.g., Kindles and Nooks), smartphone, wearable device, and the like. In an embodiment, the assistance system 100 is communicatively connected to one or more sources, one or more sensors and one or more light indicators through communication networks. The communication networks include, without limitations, wired network and/or wireless network which are explained in detail in following description.

The one or more sources refers to servers 308a, . . . , 308n (collectively referred to 308) which include, but are not limited to, servers of the assistance system 100 and/or third party servers. The servers 308 contain food recipes with one or more instruction steps of at least one food recipe of corresponding at least one food item. The one or more sensors 104 include, but are not limited to, camera, microphones, Radio Frequency Identification (RFID), load/weight sensor, accelerometer, gas chromatograph based sensor, strain gauge, and the like. The camera and the microphone are coupled to the assistance system 100. The camera is used to capture user actions performing the one or more instruction steps, number of users cooking the food item, color of the food items during cooking, and cooking process along with cooking progress from each cooking stage with respect to the corresponding one or more instruction steps etc. The microphone is used to obtain speech or audio communications from the user performing the one or more instruction steps for cooking. For example, while cooking the user may state each cooking step performed and voice of the user is received through the microphone. The RFID, the load/weight sensor, the accelerometer, the gas chromatograph based sensor, and the strain gauge are configured in one or more cooking articles. The RFID sensors detect kind of ingredients and/or kind of the one or more cooking articles used for cooking as per the one or more instruction steps. The load/weight sensors are used to detect the weight of the one or more cooking articles along with additions of the ingredients in the one or more cooking articles during each cooking step as per the one or more instruction steps. The accelerometers are used to detect activities such as pouring, stirring, scooping etc. during each cooking step. The gas chromatographs based sensors are used to detect smell or odor or aroma of the food items during each cooking step. The strain gauge is used to detect quantity of ingredients taken in the one or more cooking articles, for example quantity of ingredient in a spoon. The one or more cooking articles include, without limitations, spoons/spatulas 314, ingredient containers 320a, . . . , 320n (collectively referred to 320), stoves including gas stoves and/or electric stoves 310 and other cooking vessels and utensils. In an embodiment, the one or more cooking articles may include the ingredients to be used as per the one or more instruction steps.

In the illustrated FIG. 3, the assistance system 100 comprises one or more cooking based sensors 306a, . . . , 306n (collectively referred to 306). In an embodiment, the one or more cooking based sensors 306 are the gas chromatographs based sensors to detect the smell or odor or aroma of the food items during each cooking step. The one or more cooking articles i.e. the stove 310 comprises one or more stove sensors 312a, . . . , 312n (collectively referred to 312) which includes, without limitations, the RFID, the load/weight sensors, the accelerometers, the gas chromatograph based sensors, and the strain gauge. In an embodiment, the stove 310 and other cooking articles which can be electrically/electronically controlled are configured with transceivers (not shown). The one or more cooking articles i.e. the spatula 314 and the ingredient container 320 may comprise the RFID, the load/weight sensor, the accelerometer, and the strain gauge respectively. In an embodiment, the one or more cooking articles i.e. the spatulas 314 and the ingredient containers 320 comprise the one or more light indicators i.e. spatula light indicators 318 on the spatula 314 and ingredient light indicators 324 in the ingredient containers 320. In an embodiment, each of the one or more cooking articles is associated with identification information (ID).

In the illustrated FIG. 3, the assistance system 100 comprises the I/O interface 300, at least one central processing unit (“CPU” or “processor”) 302, and a memory 304 in accordance with some embodiments of the present disclosure.

The I/O interface 300 is a medium through which user selection of the at least one food recipe among the plurality of food recipes displayed on the assistance system 100 are received from the user associated with the assistance system 100. In an embodiment, the user selection of the at least one food recipe can be received from one or more computing devices (not shown) of the user which can act as the assistance system 100. The I/O interface 300 is used through which the one or more instruction steps corresponding to the at least one food recipe is selected by the user from the one or more sources 102 i.e. the servers 308. The I/O interface 300 receives sensor inputs indicating execution of each of the one or more instruction steps from the one or more sensors 104 i.e. from 306, 312, 316 and 322. The I/O interface 300 provides recommendation and alerts associated with the execution of each of the one or more instruction steps in real-time. In an embodiment, the I/O interface 300 is an audio/visual unit to provide the plurality of food recipes or menu of dishes. The audio/visual unit is used to provide the recommendation and the alerts. In an embodiment, the recommendation and the alerts can be provided to other computing devices of the user through the I/O interface 300. In an embodiment, the I/O interface 300 is coupled with the processor 302.

The processor 302 may comprise at least one data processor for executing program components for executing user- or system-generated sensor input for providing assistance in real-time for cooking the at least one food item. The processor 302 is configured to extract the one or more instruction steps corresponding to the at least one food recipe being selected by the user from the one or more sources 102 i.e. from the servers 308. The processor 302 provides the extracted one or more instruction steps to the audio/visual unit of the I/O interface 300 where the one or more instruction steps are played in audio form or visual form. The processor 302 receives the sensor inputs indicating execution of each of the one or more instruction steps from the one or more sensors 104 i.e. from 306, 312, 316 and 322. The processor 302 compares the sensor inputs indicating the execution of each of the one or more instruction steps with predefined cooking data of corresponding one or more instruction steps. The processor 302 provides recommendation associated with the execution of each of the one or more instruction steps in real-time based on the comparison for providing assistance for cooking the at least one food item in real-time. The processor 302 provides alerts in the form of recommendation based on at least one of identification of a change in the user actions in performing the corresponding one or more instruction steps, identifying a delay of the user actions in performing the corresponding one or more instruction steps, absence of a user while cooking, identifying a variation in the one or more cooking parameters during the corresponding one or more instruction steps and incorrect utilization of the one or more cooking articles for the corresponding one or more instruction steps. The processor 302 triggers the one or more light indicators 106 of the one or more cooking articles to be used in the particular instruction step. The processor 302 triggers the transceiver of the assistance system 100 to generate control signals for controlling the one or more cooking articles. The assistance for cooking the at least one food item in real-time and dynamically is performed by various modules which are explained in following description. The various modules are executed by the processor 302 of the assistance system 100.

The memory 304 stores instructions which are executable by the at least one processor 302. In an embodiment, the memory 304 acts as the one or more sources 102 when the memory stores the one or more instruction steps of the at least one food recipe of the at least one food item. The memory 304 stores instruction steps data, the predefined cooking data, user health data and contextual parameters. In an embodiment, the instruction steps data, the predefined cooking data, the user health data and the contextual parameters are stored as one or more data required for dynamically assisting the user for cooking in real-time. The one or more data are described in the following description of the disclosure.

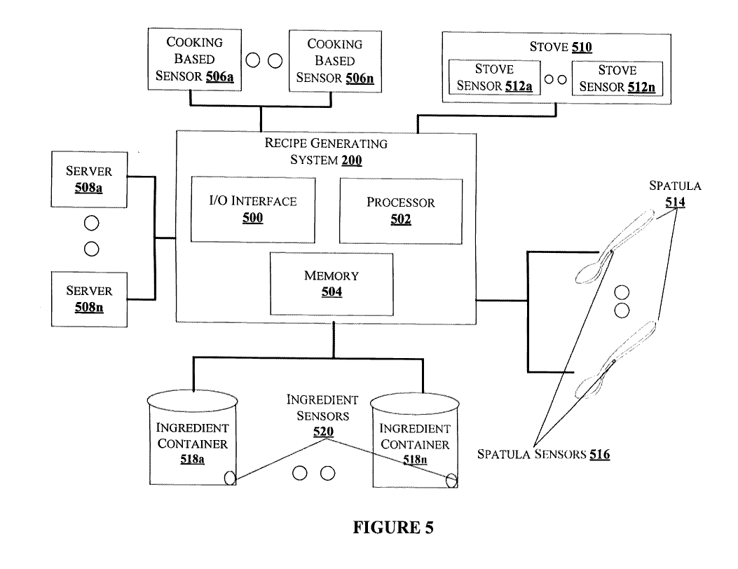

FIG. 4 illustrates a block diagram of the exemplary assistance system 100 with various data and modules for assisting the user for cooking in real-time in accordance with some embodiments of the present disclosure. In the illustrated FIG. 4, the one or more data 400 and the one or more modules 412 stored in the memory 304 are described herein in detail.

In an embodiment, the one or more data 400 may include, for example, the instruction steps data 402, the predefined cooking data 404, the user health data 406 and the contextual parameters 408 and other data 410 for dynamically providing assistance in real-time to the user for cooking the at least one food item.

The instruction steps data 402 refers to the one or more instruction steps which are cooking steps to be performed one by one. Each instruction step defines actions and/or activities to be performed by the user. For example, place an empty vessel on the stove 310, boil 1 liter of water, cut the vegetables in a specific manner, prepare dough, add spices etc. Each instruction step defines time at which the user actions are required and the one or more cooking articles to be used along with the one or more cooking parameters to be resulted, the duration of the user actions. Further, each instruction step defines the kinds of ingredients to be used for cooking, the quantity of ingredients to be used, and the kinds of the one or more cooking articles to be used. For example, sugar, two table spoons of olive oil, chili flakes, mustard seeds, usage of bigger vessel, spatulas 314, ingredient containers 320, grinders, electric stove etc. Furthermore, each instruction step defines the one or more cooking parameters to be resulted as per the user actions/activities at each cooking step i.e. at each of the one or more instruction steps. For example, at step A—the color of the puree to be dark red, at step B—specific aroma to be resulted, at step C—flame level to be reduced, at step D—moisture of mixture to be of specific type, at step E—specific texture to be resulted etc.

The predefined cooking data 404 of the corresponding one or more instruction steps are extracted from the one or more sources 102 i.e. from the servers 308. The predefined cooking data 404 includes, without limitations, predefined quantity of the at least one food item to be prepared, predefined user actions, predefined cooking parameters, predefined time for utilizing predefined cooking articles, and predefined quantity for utilizing the predefined cooking articles. The predefined quantity of the at least one food item to be prepared refers to for example, 500 grams (gm) of curry. The predefined user actions define step by step actions/activities to be performed by the user for cooking. The predefined cooking parameters define aroma or smell of the at least one food item to be resulted while cooking. The predefined time defines the time at which the one or more cooking articles and ingredients to be utilized, the user actions required for cooking, duration of the user actions, and time at which specific cooking parameter to be resulted. The predefined cooking data 404 further include the II) of each of the one or more cooking articles corresponding to the one or more instruction steps.

The sensor inputs data 405 refers to inputs received from the one or more sensors 204 i.e. 306, 312, 316 and 322 in real-time while the user is cooking by following the one or more instruction steps. The sensor inputs data 405 includes, but is not limited to, the user actions performing each of corresponding one or more instruction steps, the one or more cooking parameters of each of the corresponding one or more instruction steps, and utilization of one or more cooking articles during each of the corresponding one or more instruction steps. Also, the sensor inputs comprises time at which the user actions performed, time at which the ingredients and the one or more cooking articles are used, the duration for which the user actions are performed, the duration for which the ingredients and the one or more cooking articles are used, quantity of the at least one food item being under cooking process, quantity of ingredients and the one or more cooking articles are used, kinds of ingredients and the one or more cooking articles used and cooking progress information in each cooking step.

The user health data 406 refers to health conditions of the user cooking the at least one food item. In an embodiment, the user health data 406 may also refer to health conditions of other users consuming the at least one food item. The user health data 406 includes, without limitations, historical health data of each of the users i.e. health details stored in past. For example, for a diabetic patient, the plurality of food recipes i.e. menu of dishes is provided suitable for the diabetic patient.

The contextual parameters 408 refers to parameters including, but not limited to, environmental condition surrounded by the user, kitchen design, user's preferences of consuming the at least one food item, and frequency of consuming the at least one food item. The environmental condition refers to day time, noon time, weather condition, etc.

The other data 410 may refer to such data which can be referred for assisting the user while cooking the at least one food item.

In an embodiment, the one or more data 400 in the memory 304 are processed by the one or more modules 412 of the assistance system 100. The one or more modules 412 may be stored within the memory 304 as shown in FIG. 4. In an example, the one or more modules 412, communicatively coupled to the processor 302, may also be present outside the memory 304 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 412 may include, for example, a receiving module 414, a comparator module 416, a control module 418, and an output module 420. The memory 304 may also comprise other modules 422 to perform various miscellaneous functionalities of the assistance system 100. It will be appreciated that such aforementioned modules may be represented as a single module or a combination of different modules.

In an embodiment, the receiving module 414 receives user selection of the at least one food recipe among the plurality of food recipes from the user through the one or more computing devices and/or the assistance system 100. In an embodiment, the plurality of food recipes are menu of dishes provided based on the user health data 406 and the contextual parameters 408. Based on the at least one food recipe being selected, the receiving module 414 extracts the one or more instruction steps corresponding to the at least one food recipe from the one or more sources 102 i.e. from the servers 308 and/or from the memory 304 of the assistance system 100. In an embodiment, the extracted one or more instruction steps are provided to the output module 420. The one or more instruction steps are displayed or played in a form of audio or speech through the audio-visual unit. As the one or more instruction steps are provided to the audio-visual unit, the user in practical performs the one or more instruction steps one after the other. The user uses the one or more cooking articles, ingredients as mentioned in the one or more instruction steps based on the time and quantity being mentioned. Also, the user performs the action/activities as stated in the one or more instruction steps.

The receiving module 414 receives the sensor inputs from the one or more sensors 104 i.e. 306, 312, 316 and 322. In an embodiment, the sensor inputs are received in real-time while the user is cooking as per the one or more instruction steps. The sensor inputs as received are stored as the sensor inputs data 405 in the memory. The sensor inputs comprises the user actions performing each of corresponding one or more instruction steps, the one or more cooking parameters of each of the corresponding one or more instruction steps, and utilization of one or more cooking articles during each of the corresponding one or more instruction steps. Also, the sensor inputs comprises time at which the user actions performed, time at which the ingredients and the one or more cooking articles are used, the duration for which the user actions are performed, the duration for which the ingredients and the one or more cooking articles are used, quantity of the at least one food item being under cooking process, quantity of ingredients and the one or more cooking articles are used, kinds of ingredients and the one or more cooking articles used and cooking progress information in each cooking step.

The comparator module 416 compares the sensor inputs indicating the execution of each of the one or more instruction steps with the predefined cooking data 404 of the corresponding one or more instruction steps. The comparator module 416 verifies whether the user has performed the actions/activities, used the ingredients and the one or more cooking articles, the time of performing the user actions and using of the ingredients and the one or more cooking articles based on the corresponding one or more instruction steps at each cooking step. The comparator module 416 verifies based on normal range of values needed from the sensor inputs in the corresponding instruction step.

The output module 420 provides recommendation associated with the execution of each of the one or more instruction steps in real-time based on the comparison i.e. verification for providing assistance for cooking the at least one food item in real-time. Particularly, the recommendation is provided if the user performs the one or more instruction steps incorrectly, uses wrong cooking articles and/or the ingredients, uses incorrect quantity of the ingredients and the one or more cooking articles, performs the actions/activities at wrong time. In an embodiment, the output module 420 triggers the one or more light indicators of the one or more cooking articles. The one or more light indicators are indicated to indicate the one or more cooking articles to be used as per the one or more instruction steps. The recommendation further comprises providing alerts based on identifying a change in the user actions in performing the corresponding one or more instruction steps, identifying a delay of the user actions in performing the corresponding one or more instruction steps, absence of a user while cooking, identifying a variation in the one or more cooking parameters during the corresponding one or more instruction steps and incorrect utilization of the one or more cooking articles for the corresponding one or more instruction steps. Each of the identification in the change of the user actions in performing the corresponding one or more instruction steps is with respect to the predefined user actions in the predefined cooking data 404. The identification in the delay of the user actions in performing the corresponding one or more instruction steps is with respect to the time and duration contained in the predefined time data of the predefined cooking data 404. The alert is provided upon detecting absence of the user while cooking. For example, when the user moves out of kitchen/cooking place, user is not present in front of the stove, etc. The alert is provided upon identifying the variation in the one or more cooking parameters, for example, detecting odor of the food item, mild moisture of the food item etc. while cooking. In an embodiment, the alerts and the recommendation is provided on the assistance system 100 and/or the one or more computing devices of the user.

The control module 418 controls the one or more cooking articles based on the absence of the user while cooking and the identification of the delay of user actions in performing the corresponding one or more instruction steps. The control module 418 triggers the generation of the control signals by the transceiver of the assistance system 100. The control signals are provided to the transceiver of the one or more cooking articles. For example, upon detecting the absence of the user while cooking the flame level of the stove is reduced or the grinder is switched off or turns off the stove etc.

The other modules 422 processes all such operations required to assist the user in real-time while cooking

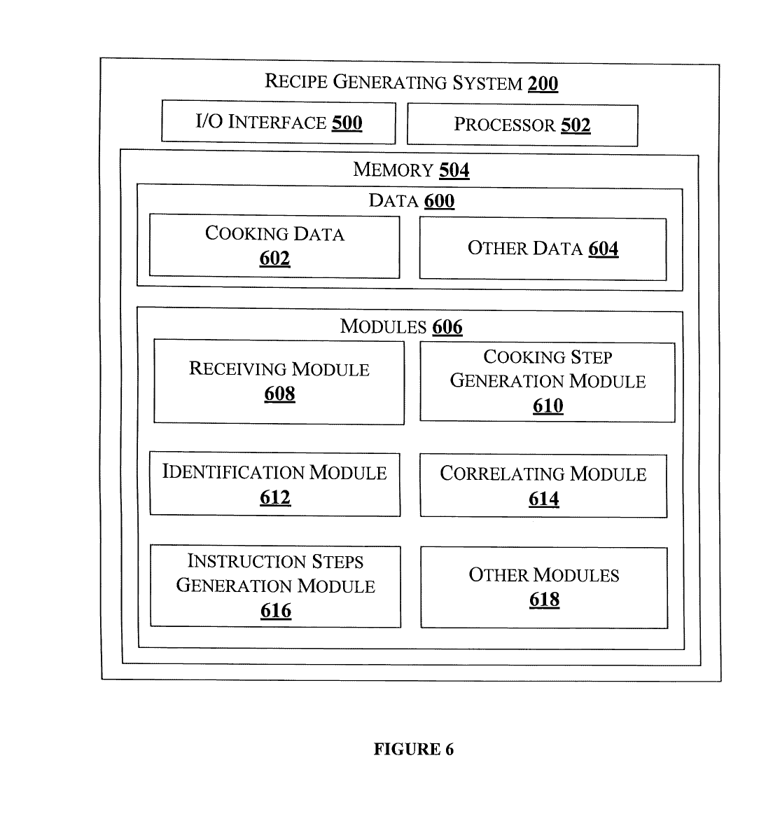

FIG. 5 illustrates a block diagram of a recipe generating system 200 comprising an I/O interface 500, a processor 502 and a memory 504 in accordance with some embodiments of the present disclosure.

Examples of the recipe generating system 100 includes, but is not limited to, mobile phone, television, digital television, laptop, tablet, desktop computer, Personal Computer (PC), contactless device, smartwatch, notebook, audio- and video-file players (e.g., MP3 players and iPODs), and e-book readers (e.g., Kindles and Nooks), smartphone, wearable device, and the like. In an embodiment, the recipe generating system 200 is communicatively connected to the one or more sources 202 and the one or more sensors 204 through communication networks as explained in FIG. 2.

In an embodiment, the one or more sources 202 and the type of the one or more sensors 204 are similar to the one or more sources 102 and the one or more sensors 104 used for the assistance system 100 as explained in FIG. 3.

In the illustrated FIG. 5, the recipe generating system 200 comprises the I/O interface 500, at least one central processing unit (“CPU” or “processor”) 502, and a memory 504 in accordance with some embodiments of the present disclosure.

The I/O interface 500 is a medium through which the sensor inputs from the one or more sensors 204. The sensors inputs includes, without limitations, user actions, ingredient details, information of one or more cooking articles being used while cooking, cooking process, cooking progress, time and duration along with quantity of usage of the one or more cooking articles along with usage of ingredients and kind of user actions being performed etc. The I/O interface 300 provides one or more instruction steps generated in audio-visual form to an audio-visual unit of the recipe generating system 200 and/or the one or more computing devices of the user. In an embodiment, the I/O interface 500 is coupled with the processor 502.

The processor 502 may comprise at least one data processor for executing program components for executing user- or system-generated sensor inputs for generating the one or more instruction steps in real-time dynamically for cooking the food item. The processor 502 is configured to generate one or more cooking steps based on the sensor inputs. For example, from video and/or audio, the processor 502 generates the one or more cooking steps at each stage while the user in the video and/or the audio is cooking. The processor 502, for each cooking step, identifies the user actions performed for the cooking, the one or more cooking parameters associated the cooking, the utilization of one or more cooking articles associated with the cooking, the cooking progress, the cooking process and the time duration and quantity of utilizing the one or more cooking articles. For example, the processor 502 identifies that the user has poured the water in the vessel at expiry of 15 seconds from the heating of the vessel, the user has utilized the ingredients such as chili flakes, onions etc. in next 20 seconds, etc. and the aroma while cooking is strong at next 30^{th} seconds. The processor 502 correlates each of the user actions performed for the cooking, the one or more cooking parameters associated the cooking, the utilization of one or more cooking articles associated with the cooking, the cooking progress, the cooking process and the time, duration and the quantity of utilizing the one or more cooking articles with each other. The processor 502 generates the one or more instruction steps of whole food recipe based on the correlation. The generation of the one or more instruction steps of the food recipe for cooking the at least one food item in real-time and dynamically is performed by various modules which are explained in following description. The various modules are executed by the processor 502 of the recipe generating system 200.

The memory 504 stores instructions which are executable by the at least one processor 502. The memory 504 stores cooking data for each cooking step. In an embodiment, the cooking data are stored as one or more data required for dynamically generating the one or more instruction steps of the food recipe in real-time. The one or more data are described in the following description of the disclosure.

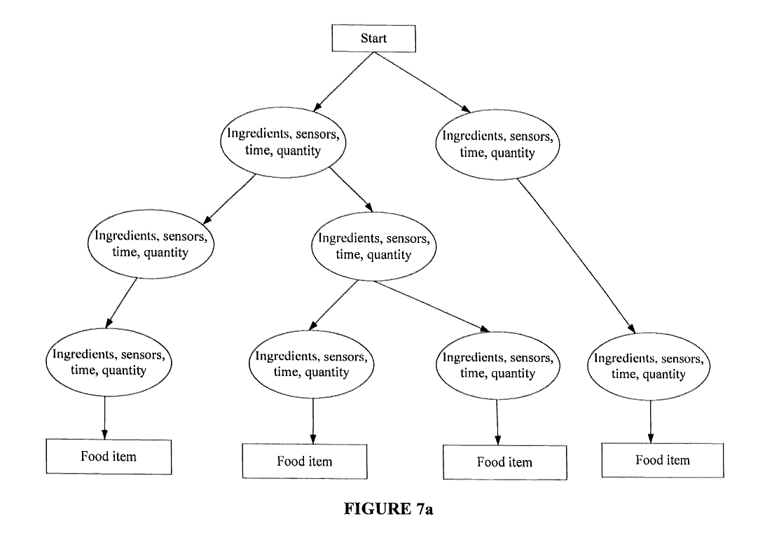

FIG. 6 illustrates a block diagram of the exemplary recipe generating system 200 with various data and modules for generating the one or more instruction steps of the food recipe in real-time in accordance with some embodiments of the present disclosure. In the illustrated FIG. 6, the one or more data 600 and the one or more modules 606 stored in the memory 504 are described herein in detail.

In an embodiment, the one or more data 600 may include, for example, the cooking data 602, and other data 604 for generating the one or more instruction steps of the food recipe in real-time and dynamically.

The cooking data 602 refers to the one or more food preparation steps performed one by one by the user. The cooking data 602 contains raw data of cooking obtained by referring to a recipe book, seeing a video stream and/or listening to an audio stream. Each food preparation step defines actions and/or activities performed by the user. For example, placement of an empty vessel on the stove, boiling 1 liter of water, cutting the vegetables in a specific manner, preparing dough, add spices etc. Each food preparation step defines time at which the user actions are performed and the one or more cooking articles used along with the one or more cooking parameters, the duration of the user actions performing while preparation. Further, each food preparation step defines the kinds of ingredients used for cooking, the quantity of ingredients used, and the kinds of the one or more cooking articles used. For example, sugar, two table spoons of olive oil, chili flakes, mustard seeds, usage of bigger vessel, spatulas, ingredient containers, grinders used, electric stove used etc. Furthermore, each food preparation step defines the one or more cooking parameters resulted as per the user actions/activities. For example, at step A—the color of the puree is dark red, at step B—specific aroma is resulted, at step C—flame level is reduced, at step D—moisture of mixture is a specific type, at step E—specific texture is resulted etc.

The other data 604 may refer to such data which can be referred for generating the one or more instruction steps of the food recipe in real-time.

In an embodiment, the one or more data 600 in the memory 504 are processed by the one or more modules 606 of the recipe generating system 200. The one or more modules 606 may be stored within the memory 504 as shown in FIG. 6. In an example, the one or more modules 606, communicatively coupled to the processor 502, may also be present outside the memory 504 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 606 may include, for example, a receiving module 608, a cooking step generation module 610, an identification module 612, correlating module 614, and an instruction steps generation module 616. The memory 504 may also comprise other modules 618 to perform various miscellaneous functionalities of the recipe generating system 200. It will be appreciated that such aforementioned modules may be represented as a single module or a combination of different modules.

In an embodiment, the receiving module 414 receives the sensors inputs from the one or more sensors 204. The sensor inputs includes, without limitations, the user actions performed for the cooking, the one or more cooking parameters associated the cooking, the utilization of one or more cooking articles associated with the cooking, the cooking progress, the cooking process and the time duration and quantity of utilizing the one or more cooking articles. The information includes, without limitations, the user actions performed for the cooking, the one or more cooking parameters associated the cooking, the utilization of one or more cooking articles associated with the cooking, the cooking progress, the cooking process and the time duration and quantity of utilizing the one or more cooking articles from the video stream or the audio stream or the recipe books.

The cooking step generation module 610 generates the one or more cooking steps based on the received sensor inputs. In an embodiment, the video stream or the audio steam or the recipe books are packetized into different streams and for each streams, the one or more cooking steps are generated.

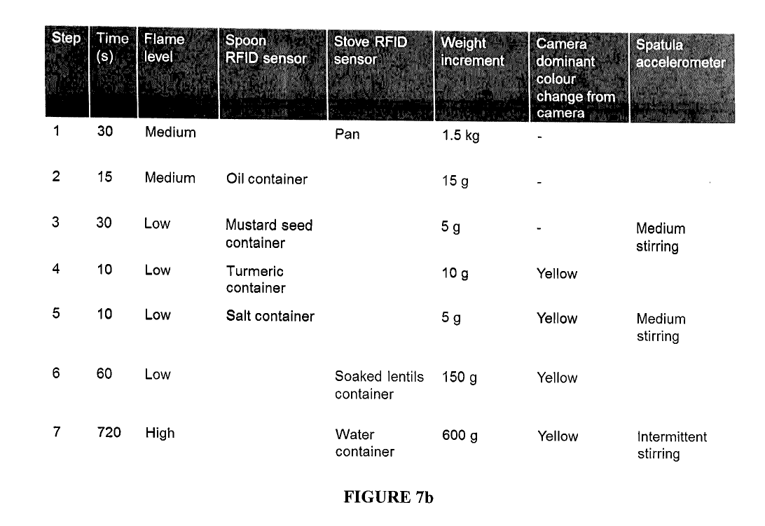

The identification module 612 identifies the time at which the user actions performed, time at which the ingredients and the one or more cooking articles are used, the duration for which the user actions are performed, the duration for which the ingredients and the one or more cooking articles are used, quantity of the at least one food item being under cooking process, quantity of ingredients and the one or more cooking articles are used, kinds of ingredients and the one or more cooking articles used and cooking progress information in each cooking step. Each cooking step identified with various cooking information is stored as graph as shown in FIG. 7a. Particularly, FIG. 7a shows the identification of the time, duration, ingredients etc. at each cooking step along with the cooking progress at each cooking step.

The correlating module 614 correlates the user actions, the one or more cooking parameters, the one or more cooking articles, and the time duration of each of the corresponding one or more cooking steps with each other. For example, at step A the user has stirred the mixture in the vessel for 5 minutes and used the chili flakes after expiry of 8 seconds of heating the vessel.

The instruction steps generation module 616 generates the one or more instruction steps of the food recipe in real-time using the correlation from each of the corresponding one or more cooking steps for cooking the food item. The generated one or more instruction steps are stored in the memory 504 which could be used for assisting the user while cooking. FIG. 7b shows an exemplary diagram illustrating the one or more instruction steps generated for each cooking step. The one or more instruction steps generated is used as cooking data 404 and 602 respectively.

The other modules 618 processes all such operations required to generate the one or more instruction steps of the food recipe in real-time.

In an embodiment, the assistance system 100 and the recipe generating system 200 can be configured in a single system. In such a case, the system functions as the assistance system 100 if the user wishes for assistance while cooking or the system functions as the recipe generating system 200 if the user wishes to generate the instruction steps.

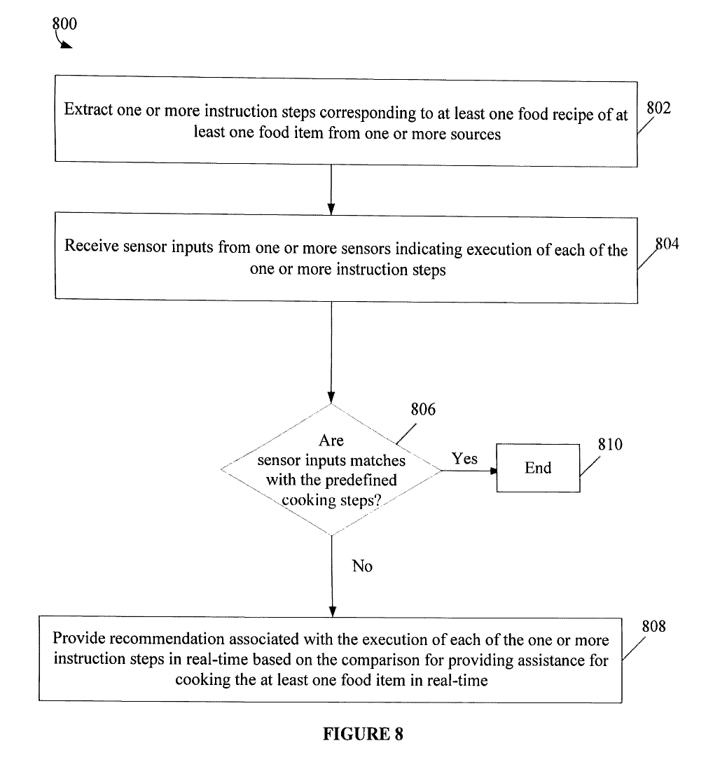

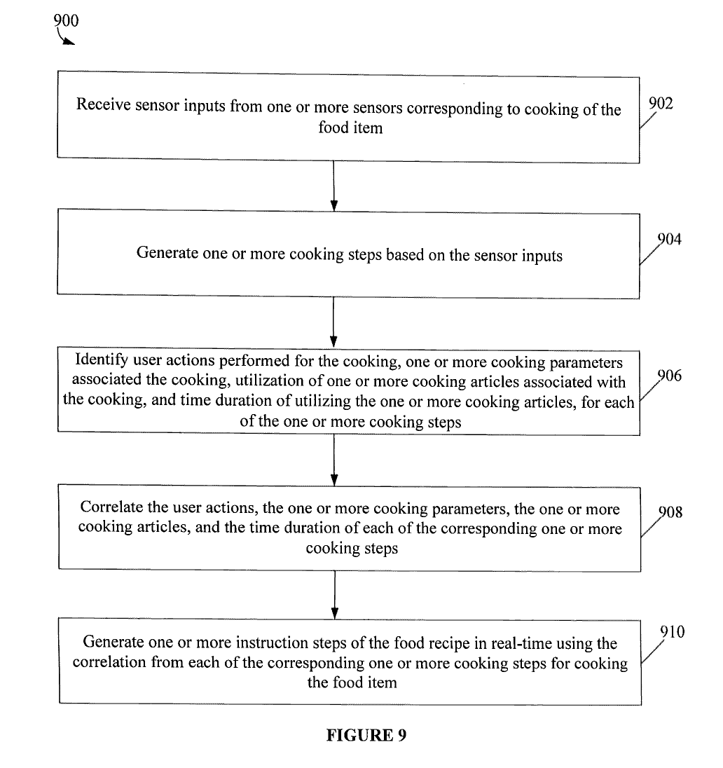

As illustrated in FIGS. 8 and 9, the method comprises one or more blocks for dynamically providing assistance for cooking and generating instruction steps in real-time for cooking respectively. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

FIG. 8 shows a flowchart illustrating a method 800 for providing assistance in real-time for cooking food items in accordance with some embodiments of the present disclosure.

At block 802, the one or more instruction steps corresponding to the at least one food recipe of the at least one food item are extracted from the one or more sources 102. The one or more extracted based on the user selection of the at least one food recipe among the plurality of food recipes being displayed and/or provided to the assistance system 100 and/or to the one or more computing devices of the user. The plurality of food recipes are provided and/or displayed for selection from the user based on the user health data 406 and the contextual parameters 408 based on the user. In an embodiment, each of the extracted one or more instruction steps is provided to the audio-visual unit associated with the assistance system 100.

At block 804, the sensor inputs are received from the one or more sensors indicating execution of each of the one or more instruction steps. In an embodiment, the sensor inputs comprises the user actions for performing each of corresponding the one or more instruction steps, the one or more cooking parameters of each of the corresponding the one or more instruction steps, and the utilization of the one or more cooking articles during each of the corresponding one or more instruction steps.

At block 806, a condition is checked whether the received sensor inputs indicating the execution of each of the one or more instruction steps matches with the predefined cooking data 404 of corresponding one or more instruction steps. Particularly, the received sensor inputs indicating the execution of each of the one or more instruction steps is compared with the predefined cooking data 404. The predefined cooking data of the corresponding one or more instruction steps comprises the predefined user actions, the predefined cooking parameters, the predefined time for utilizing predefined cooking articles, and the predefined quantity for utilizing the predefined cooking articles. The process goes to block 810 via “Yes” where the process is ended when the received sensor inputs indicating the execution of each of the one or more instruction steps matches with the predefined cooking data 404. If the received sensor inputs indicating the execution of each of the one or more instruction steps do match with the predefined cooking data 404, then the process goes to block 808 via “No”.

At block 808, the recommendation associated with the execution of each of the one or more instruction steps is provided in real-time based on the comparison for providing assistance for cooking the at least one food item in real-time. In an embodiment, method 800 comprises recommendation by indicating the one or more light indicators 106 of the one or more cooking articles indicating the one or more cooking articles to be used. Further, the recommendation comprises providing alerts based on identifying a change in the user actions in performing the corresponding one or more instruction steps, identifying a delay of the user actions in performing the corresponding one or more instruction steps, absence of a user while cooking, identifying a variation in the one or more cooking parameters during the corresponding one or more instruction steps and incorrect utilization of the one or more cooking articles for the corresponding one or more instruction steps. Furthermore, the method 800 comprises controlling the one or more cooking articles based on at least one of the absence of the user while cooking and the identification of delay of user actions in performing the corresponding one or more instruction steps.

FIG. 9 shows a flowchart illustrating a method for generating instruction steps of a food recipe in real-time for cooking food items in accordance with some embodiments of the present disclosure.

At block 902, the sensor inputs are received from the one or more sensors 204 corresponding to cooking of the food item.

At block 904, the one or more cooking steps at each cooking process and cooking process are generated based on the sensor inputs.

At block 906, the user actions performed for the cooking, the one or more cooking parameters associated the cooking, the utilization of the one or more cooking articles associated with the cooking, and time duration of utilizing the one or more cooking articles, are identified for each of the one or more cooking steps.

At block 908, the user actions, the one or more cooking parameters, the one or more cooking articles, and the time duration of each of the corresponding one or more cooking steps are correlated with one another.

At block 910, the one or more instruction steps of the food recipe are generated in real-time using the correlation from each of the corresponding one or more cooking steps for cooking the food item.

### Computer System

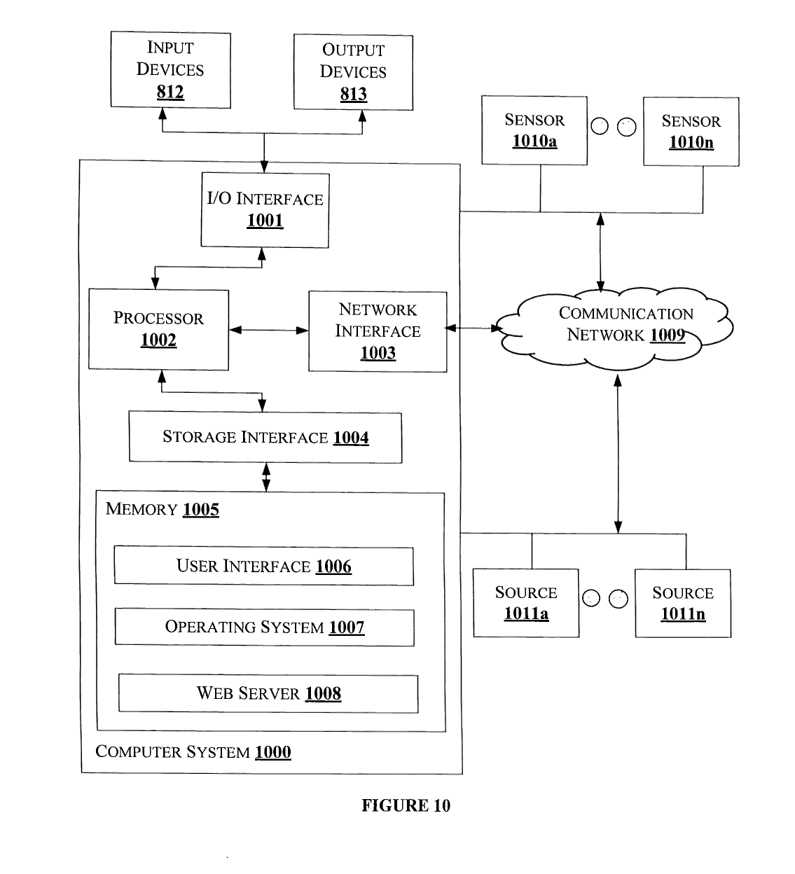

FIG. 10 illustrates a block diagram of an exemplary computer system 1000 for implementing embodiments consistent with the present disclosure. In an embodiment, the computer system 1000 is used to implement the assistance system 100 and the recipe generating system 200 respectively. The computer system 1000 dynamically provides assistance and generates instruction steps in real-time for cooking. The computer system 1000 may comprise a central processing unit (“CPU” or “processor”) 1002. The processor 1002 may comprise at least one data processor for executing program components for executing user- or system-generated sensor inputs. The processor 1002 may include specialized processing units such as integrated system (bus) controllers, memory management control units, floating point units, graphics processing units, digital signal processing units, etc.

The processor 1002 may be disposed in communication with one or more input/output (I/O) devices (not shown) via I/O interface 1001. The I/O interface 1001 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 1001, the computer system 1000 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma. Plasma display panel (PDP), Organic light-emitting diode display (OLED) or the like), audio speaker, etc.

In some embodiments, the computer system 1000 is connected to the one or more sources 1010a, . . . , 1011n which is similar to the one or more sources 102 and the one or more sensors 1010a, . . . , 1010n which depicts the one or more sensors 104 through a communication network 1009. The processor 1002 may be disposed in communication with the communication network 1009 via a network interface 1003. The network interface 1003 may communicate with the communication network 1009. Also, the processor 1002 is connected to one or more light indicators (not shown) which acts as the one or more light indicators 106. The network interface 1003 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1009 may include, without limitation, a direct interconnection, local area network (LAN), wide area network (WAN), wireless network (e.g., using Wireless Application Protocol), the Internet, etc. Using the network interface 1003 and the communication network 1009, the computer system 1000 may communicate with the one or more sources 1011a, . . . , 1011n, the one or more sensors 1010a, . . . , 1010n and the one or more light indicators. The network interface 1003 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 1009 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 1002 may be disposed in communication with a memory 1005 (e.g., RAM, ROM, etc. not shown in FIG. 10) via a storage interface 1004. The storage interface 1004 may connect to memory 1005 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 1005 may store a collection of program or database components, including, without limitation, user interface 1006, an operating system 1007, web server 1008 etc. In some embodiments, computer system 1000 may store user/application data 1006, such as the data, variables, records, etc. as described in this disclosure. Such databases may be implemented as fault-tolerant, relational, scalable, secure databases such as Oracle or Sybase.

The operating system 1007 may facilitate resource management and operation of the computer system 1000. Examples of operating systems include, without limitation, Apple Macintosh OS X, Unix, Unix-like system distributions (e.g., Berkeley Software Distribution (BSD), FreeBSD, NetBSD, OpenBSI), etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In some embodiments, the computer system 1000 may implement a web browser 1007 stored program component. The web browser 1008 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 1008 may utilize facilities such as AJAX, DHTML, Adobe Flash, JavaScript, Java, Application Programming Interfaces (APIs), etc. In some embodiments, the computer system 1000 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 600 may implement a mail client stored program component. The mail client may be a mail viewing application, such as Apple Mail, Microsoft Entourage. Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CI) ROMs, DVDs, flash drives, disks, and any other known physical storage media.

Advantages of the embodiment of the present disclosure are illustrated herein.

Embodiments of the present disclosure provides a solution for assisting the cook in real-time and dynamically. In such a way, the mistakes of the user while cooking can be corrected and corrective measures can be incorporated while cooking in real-time. This saves time and efforts of the cooking in cooking.

Embodiments of the present disclosure provide accurate assistance while cooking by providing an interactive system to the user. In such a way, the mistakes of the user while cooking can be reduced.

Embodiments of the present disclosure use Internet of Things (IoT), that is information is collected from various sensors, sources along with user's personal preferences and behaviour patterns of the user. In such a case, an accurate way of assistance can be provided using information of the IoTs.

Embodiments of the present disclosure generate the instructions steps in real-time eliminating the offline mode of generation. In such a way, any cooking step can be implemented accurately without wasting time in understanding the cooking step manually by the cook.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 8 and 9 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Assistance System |
| 102a, . . . , 102n | Sources |
| 104a, . . . 104n | Sensors |
| 106a, . . . , 106n | Light Indicators |
| 206a, . . . , 206n | Sources |
| 200 | Recipe Generating System |
| 202a, . . . , 202n | Sources |
| 204a, . . . , 204n | Sensors |
| 300 | I/O Interface |
| 302 | Processor |
| 304 | Memory |
| 306a, . . . , 306n | Cooking Based Sensors |
| 308a, . . . , 308n | Servers |
| 310 | Stove |
| 312a, . . . , 312n | Stove Sensors |
| 314 | Spatula |
| 316 | Spatula Sensors |
| 318 | Spatula Light Indicators |
| 320 | Ingredient Containers |
| 322 | Ingredient Sensors |
| 324 | Ingredient Light Indicators |
| 400 | Data |
| 402 | Instruction Steps Data |
| 404 | Predefined Cooking Data |
| 406 | User Health Data |
| 408 | Contextual Parameters |
| 410 | Other Data |
| 412 | Modules |
| 414 | Receiving Module |
| 416 | Comparator Module |
| 418 | Control Module |
| 420 | Output Module |
| 418 | Other Modules |
| 500 | I/O Interface |
| 502 | Processor |
| 504 | Memory |
| 506a, . . . , 506n | Cooking Based Sensors |
| 508a, . . . , 508n | Servers |
| 510 | Stove |
| 512a, . . . , 512n | Stove Sensors |
| 514 | Spatula |
| 516 | Spatula Sensors |
| 518 | Ingredient Containers |
| 520 | Ingredient Sensors |
| 600 | Data |
| 602 | Cooking Data |
| 604 | Other Data |
| 606 | Modules |
| 608 | Receiving Module |
| 610 | Cooking Step Generation Module |
| 612 | Identification Module |
| 614 | Correlating Module |
| 616 | Instruction Steps Generation Module |
| 618 | Other Modules |
| 1000 | Computer System |
| 1001 | I/O Interface |
| 1002 | Processor |
| 1003 | Network Interface |
| 1004 | Storage Interface |
| 1005 | Memory |
| 1006 | User Interface |
| 1007 | Operating System |
| 1008 | Web Server |
| 1009 | Communication Network |
| 1010a, . . . , 1010n | Sensors |
| 1011a, . . . , 1011n | Sources |
| 1012 | Input Devices |
| 1013 | Output Devices |

We claim:

1. A method for providing assistance for cooking food items in real-time, the method comprising:
extracting, by an assistance system, one or more instruction steps corresponding to at least one food recipe of at least one food item from one or more sources;
receiving, by the assistance system, sensor inputs from one or more sensors indicating execution of each of the one or more instruction steps, wherein the sensor inputs comprises user actions for performing each of corresponding one or more instruction steps, one or more cooking parameters of each of the corresponding one or more instruction steps, and utilization of one or more cooking articles during each of the corresponding one or more instruction steps;
comparing, by the assistance system, the sensor inputs indicating the execution of each of the one or more instruction steps with predefined cooking data of corresponding one or more instruction steps; and
providing, by the assistance system, recommendation associated with the execution of each of the one or more instruction steps in real-time based on the comparison for providing assistance for cooking the at least one food item in real-time.

2. The method as claimed in claim 1 further comprising receiving user selection of the at least one food recipe among a plurality of food recipes displayed from the user associated with the assistance system.

3. The method as claimed in claim 2, wherein the at least one food recipe displayed for selection from the user is based on at least one of user health data and contextual parameters based on the user.

4. The method as claimed in claim 1, further comprising providing by the assistance system, each of the extracted one or more instruction steps to audio-visual unit associated with the assistance system.

5. The method as claimed in claim 4, further comprising indicating by the assistance system, the one or more cooking articles to be used in one of the one or more instruction steps through one or more light indicators configured in each of the one or more cooking articles.

6. The method as claimed in claim 1, wherein the predefined cooking data of the corresponding one or more instruction steps comprises predefined user actions, predefined cooking parameters, predefined time for utilizing predefined cooking articles, and predefined quantity for utilizing the predefined cooking articles.

7. The method as claimed in claim 1, wherein providing the recommendation comprises providing alerts based on at least one of identifying a change in the user actions in performing the corresponding one or more instruction steps, identifying a delay of the user actions in performing the corresponding one or more instruction steps, absence of a user while cooking, identifying a variation in the one or more cooking parameters during the corresponding one or more instruction steps and incorrect utilization of the one or more cooking articles for the corresponding one or more instruction steps.

8. The method as claimed in claim 7 further comprising controlling, by the assistance system, the one or more cooking articles based on at least one of the absence of the user while cooking and the identification of delay of user actions in performing the corresponding one or more instruction steps.

9. An assistance system for providing assistance for cooking food items in real-time comprising:
a processor;
a memory communicatively coupled to the processor, wherein the memory stores processor-executable instructions, which, on execution, cause the processor to:
extract one or more instruction steps corresponding to at least one food recipe of at least one food item from one or more sources;
receive sensor inputs from one or more sensors indicating execution of each of the one or more instruction steps, wherein the sensor inputs comprises user actions for performing each of corresponding one or more instruction steps, one or more cooking parameters of each of the corresponding one or more instruction steps, and utilization of one or more cooking articles during each of the corresponding one or more instruction steps;
compare the sensor inputs indicating the execution of each of the one or more instruction steps with predefined cooking data of corresponding one or more instruction steps; and
provide recommendation associated with the execution of each of the one or more instruction steps in real-time based on the comparison for providing assistance for cooking the at least one food item in real-time.

10. The assistance system as claimed in claim 9 is communicatively connected to the one or more sources, the one or more cooking articles and the one or more sensors associated to the one or more cooking articles.

11. The assistance system as claimed in claim 9, wherein the processor is further configured to receive user selection of the at least one food recipe among a plurality of food recipes displayed from the user associated with the assistance system.

12. The assistance system as claimed in claim 11, wherein the at least one food recipe displayed for selection from the user is based on at least one of user health data and contextual parameters based on the user.

13. The assistance system as claimed in claim 9, wherein the processor is further configured to provide each of the extracted one or more instruction steps to audio-visual unit associated with the assistance system.

14. The assistance system as claimed in claim 13, wherein the processor is further configured to indicate the one or more cooking articles to be used in one of the one or more instruction steps through one or more light indicators configured in each of the one or more cooking articles.

15. The assistance system as claimed in claim 9, wherein providing the recommendation comprises providing alerts based on at least one of identifying a change in the user actions in performing the corresponding one or more instruction steps, identifying a delay of the user actions in performing the corresponding one or more instruction steps, absence of a user while cooking, identifying a variation in the one or more cooking parameters during the corresponding one or more instruction steps and incorrect utilization of the one or more cooking articles for the corresponding one or more instruction steps.

16. The assistance system as claimed in claim 15, wherein the processor is further configured to control the one or more cooking articles based on at least one of the absence of the user while cooking and the identification of delay of user actions in performing the corresponding one or more instruction steps.

17. A non-transitory computer readable medium including instructions stored thereon that when processed by a processor cause an assistance system for providing assistance for cooking food items in real-time by performing acts of:
extracting one or more instruction steps corresponding to at least one food recipe of at least one food item from one or more sources;
receiving sensor inputs from one or more sensors indicating execution of each of the one or more instruction steps, wherein the sensor inputs comprises user actions for performing each of corresponding one or more instruction steps, one or more cooking parameters of each of the corresponding one or more instruction steps, and utilization of one or more cooking articles during each of the corresponding one or more instruction steps;
comparing the sensor inputs indicating the execution of each of the one or more instruction steps with predefined cooking data of corresponding one or more instruction steps; and
providing recommendation associated with the execution of each of the one or more instruction steps in real-time based on the comparison for providing assistance for cooking the at least one food item in real-time.
